(19) United States
(12) Patent Application Publication
(10) Pub. No.: US 2003/0121152 A1
(43) Pub. Date: Jul. 3, 2003

(54) Methods for recreating fuel pump bearings

(76) Inventor: David L. Johnson, Parsippany, NJ (US)

Correspondence Address: EDWARDS & ANGELL, LLP, P.O. BOX 9169, BOSTON, MA, 02209, US

(21) Appl. No.: 10/309,559

(22) Filed: Dec. 4, 2002

Related U.S. Application Data
(60) Provisional application No. 60/336,643, filed on Dec. 4, 2001.

(51) Int. Cl. B23P 6/00; B23P 19/04

(52) U.S. Cl. 29/898.01; 29/402.04; 29/402.06; 29/402.18

(57) ABSTRACT

Disclosed are processes to recreate the as-manufactured or as-installed shape and finish to worn fuel pump bearings, wherein such processes entail either restoring or replacing the bearings, and further entail placing a resurfacing compound and a final top coating onto the top surface of the bearing.

### CROSS REFERENCE TO RELATED APPLICATION

This application claims priority from, and incorporates by reference the entirety of U.S. Provisional Patent Application Serial No. 60/336,643, which was filed on Dec. 4, 2001.

### BACKGROUND OF THE INVENTION

1. FIELD OF THE INVENTION

The present invention relates to industrial machinery, and, in particular, to industrial gas turbines. More particularly, the present invention provides methods for recreating the as-manufactured shape, dimensions and finish of fuel pump bearings used in industrial gas turbines.

2. DESCRIPTION OF RELATED ART

Among the numerous components of industrial gas turbines are fuel pumps, which pump fuel to turbine engines at very high pressures and volumetric flow rates. The internal components of a fuel pump for an exemplary industrial gas turbine are shown in FIGS. 1-5, and include two primary impeller gears 10, 12, which are supported on their ends 14, 16 and 18, 20 by four bearings 22, which provide a high-pressure chamber between the impeller gears and the pump housing (see, in particular, FIG. 5). The four bearings 22 are generally denoted as the inner driven bearing 22A, the inner driver bearing 22B, the outer driven bearing 22C, and the outer driver bearing 22D (see FIG. 2).

As manufactured, fuel pump bearings 22 are substantially smooth and friction-free in order to resist the generation of wear upon their surfaces. Despite this, however, bearing surfaces tend to become worn due to high torsion friction that results from the friction energy generated by the contact area between the impeller gears 10, 12 and the bearings 22, as well as from the pressure forces exerted by the impeller gears due to pressure of the fuel that is pumped by the fuel pump.

The pathway of fuel within the bearings 22 and impeller gears 10, 12 is depicted by the single arrow in FIG. 5, while the direction of fluid pressure caused by fuel flow is depicted by the double arrow in the same figure.

Numerous solutions have been proposed to prevent the generation of wear on fuel pump bearings. Implementation of such solutions, however, has not only failed to prevent bearing wear, but has failed even to curb the generation of wear for more than an unacceptably short period of time.

For example, some have manufactured such bearings from materials with a high lead content, thus providing inherently slippery contact surfaces for the bearings, and, in turn, supposedly curbing friction and delaying wear generation. The drawbacks to such an approach are that incorporation of lead-based materials renders the bearings soft, thus greatly expediting erosion and eliptication of the bearings, and increasing the likelihood that the top surfaces of the bearings will pit and/or cavitate in response to the high fuel pressure environment encountered within the fuel pump.

Others have designed bearings to include lubrication grooves 24 (see FIG. 4), which also are referred to as “journal skates” within the art, and which allow fuel being pumped by the fuel pump to be continually flowed/routed to the area between the impeller gears and the bearings, thus providing lubrication and cooling to this area and, in doing so, supposedly curbing friction and delaying wear generation.

In practice, however, journal skates 24 in bearings made of softer base material are problematic. For example, they become worn after an unacceptably short period of use and, once worn, provide a pathway for high-pressure fluid to leak from the pumping chamber to the low-pressure area of the fuel pump. Such leakage not only will cause a reduction of performance in the fuel pump, but also is quite dangerous, because if fuel oil leaks outside of the fuel pump housing and into the engine containment cell of the gas turbine, there is a risk of fire.

Still others have coated fuel pump bearings with an anti-galling compound (e.g., a graphite/lead spray) prior to installation of the bearings in order to provide the bearings with friction-resistant surface lubrication that, in turn, supposedly delays wear generation. It has been found, however, that such coatings disappear quickly following their application, even if applied quite thickly.

Because those in the art have been unable to prevent the problem of bearing wear, what is inevitably occurring (and likely will continue to occur for some time) is that bearings in place in fuel pumps are becoming worn to an extent wherein the fuel pump can no longer effectively function.

For some time, retrofittable replacement bearings were widely available and, therefore, relatively inexpensive. This is no longer the case, however, as replacement of worn bearings has become extremely cost prohibitive.

As such, a need exists for a process to recreate the as-manufactured shape and finish to worn bearings, wherein such process is not unduly expensive or time consuming, and wherein such process is implementable regardless of the amount of bearing wear that has occurred, and regardless of the step(s) (e.g., manufacturing the bearing from a high lead content material, designing the bearings to include journal skates, and/or coating the bearings with an anti-galling compound) that may have been taken prior to or following installation of the bearings in an effort to curb wear.

### SUMMARY OF THE INVENTION

The present invention provides a process that meets these, and other needs by recreating the original (i.e., as-installed, as-manufactured) shape and finish to fuel pump bearings.

The terms “as-manufactured” and “as-installed,” as used herein, are intended to refer to the condition (i.e., appearance, shape and/or dimensions) of the bearings upon their initial placement within a usage environment, but prior to their actual use in such an environment.

In accordance with an exemplary aspect of the invention, the process first entails carefully removing and then cleaning and inspecting the bearings. At that point, a determination is made as to whether the bearing cores can be recreated by being restored or, instead, whether the cores have suffered so much damage/degradation that they should be recreated by being replaced.

If the cores can be restored, the bearings are machined, if necessary, to remove enough of the existing bearing surface(s) to allow for application of a minimum thickness of one or more resurfacing compounds and, thereafter, a top coating material. Preferably, the bearings are subjected to one or more post-machining processes, then are inspected and cleaned prior to application of the top coating material.

Further machining and/or treatment may be called for during the bearing restoration process in order to repair damage (e.g., pitting and/or cavitation) to the bearings, and/or to machine away excess resurfacing compound on the bearings.

If the cores are too excessively damaged/degraded to be restored either at all or economically, replacement inner and/or outer cores are fashioned, e.g., via machining metallic stock on a lathe. The new cores are then visually inspected and then cleaned, after which the top coating material is applied thereto.

Once the resurfacing compound(s) are applied thereto, the bearings are placed in a vacuum chamber or other suitable environment for a predetermined time period. The bearings are then machined, after which a predetermined thickness of a final top coating material is applied to the bearings. Following application of the final coating, the bearings are cured, after which they are given one or more final inspections prior to reinstallation within the fuel pump.

Care is taken during the entire process to avoid physically impacting the bearings, to avoid heating the bearings above a predetermined temperature, and to notice and eliminate the presence of any air bubbles and air pockets during and following application of the resurfacing compound to the bearings

Still other aspects, embodiments and advantages of the present invention are discussed in detail below.

### BRIEF DESCRIPTION OF THE DRAWINGS

For a fuller understanding of the nature and desired objects of the present invention, reference is made to the following detailed description taken in conjunction with the accompanying figures wherein like reference characters denote corresponding parts throughout the several illustrated views, and wherein:

FIG. 1 illustrates an exploded view of impeller gears and bearings that comprise an exemplary fuel pump;

FIG. 2 illustrates a more detailed, exploded view of the components depicted in FIG. 1

FIG. 3A and 3B illustrate cross sectional views, taken, respectively along the lines 3A-3A and 3B-3B of FIG. 2, of an inner bearing (see FIG. 3A) and an outer bearing (see FIG. 3B);

FIGS. 4A and 4B illustrate top views of the top surface of an inner or outer driven bearing (see FIG. 4A) and an inner or outer driver bearing (see FIG. 4B);

FIG. 5 illustrates an end view of the impeller gears and bearings of FIG. 1 in an assembled condition;

FIG. 6 illustrates a graph depicting the limiting pressure x velocity (PV) for Fluoralon B5525 without external lubrication, and also showing its coefficient of friction;

FIGS. 7A-7F illustrate perspective views of the machining of material to create a replacement outer bearing core;

FIGS. 8A-8F illustrate perspective views of the machining of material to create a replacement inner bearing core; and

FIG. 9 is a flow diagram illustrating the process of restoring or replacing a fuel pump bearing to result in a final product, which resembles the finish and dimensions of an as-manufactured fuel pump bearing.

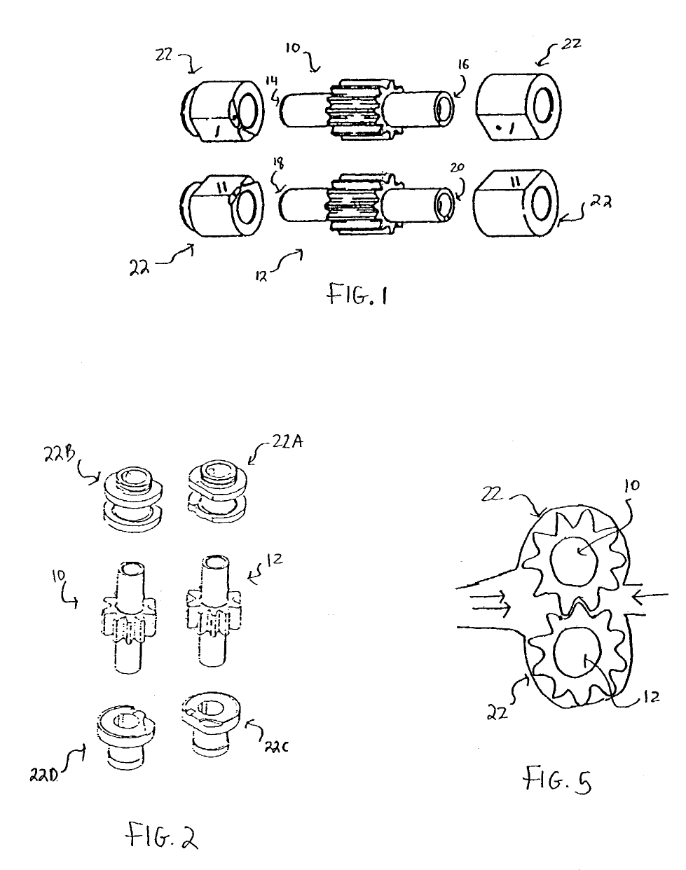

### DETAILED DESCRIPTION OF THE INVENTION

The present invention provides processes to recreate the asmanufactured or as-installed shape and finish to worn fuel pump bearings 22, wherein such processes are neither unduly expensive nor time consuming, and are implementable regardless of the step(s) (e.g., manufacturing the bearing from a high lead content material, designing the bearings to include journal skates, and/or coating the bearings with an anti-galling compound), that may have been taken prior to or following installation of the bearings in an effort to curb wear thereof.

Specifically, the present invention provides related processes for restoring worn bearings that are capable of being restored, and for replacing the cores of bearings that have undergone excessive wear, such that their inner and/or outer cores are too damaged to be repaired either at all or in an economical manner. These related processes of the present invention are shown in the flow diagram 100 of FIG. 9.

As shown in FIG. 9, the bearings are first removed, cleaned and inspected to determine the extent of damage thereto. If the bearing cores are capable of being repaired, the cores are refurbished and then prepared for machining. Thereafter, their surface is restored, and they are subjected to one or more post-machining treatments. The cores are then subjected to further refurbishing, are inspected and then cleaned, after which top coating is applied thereto.

On the other hand, if the bearing cores are too damaged to allow for them to be repaired either at all in a time- or cost-efficient manner, new cores are fashioned/machined. The new cores are inspected, cleaned and a top coating is applied thereto.

The various steps of these restoration/replacement processes are described in more detail below.

In an exemplary embodiment of the present invention, each of the bearings 22A, 22B, 22C, 22D (see FIG. 2) is first removed from its respective impeller gear 10, 12. This may be accomplished using techniques and extraction tools/equipment generally known in the art. The bearings 22 may be removed individually or, if dictated by the structure of the pump housing (not shown), in pairs.

Care should be taken to ensure that the bearings 22 are not mishandled prior to, during, or following the entire restoration process, as physical impact upon the bearings may render them unfit for optimal, or even adequate usage despite it/they having an appearance to the contrary. Moreover, if the bearings contain lead, it is preferable (in order to avoid the risk of lead precipitation) that the bearings not be heated to a temperature above 450° F. for a duration of greater than fifteen consecutive minutes during any portion of the restoration process.

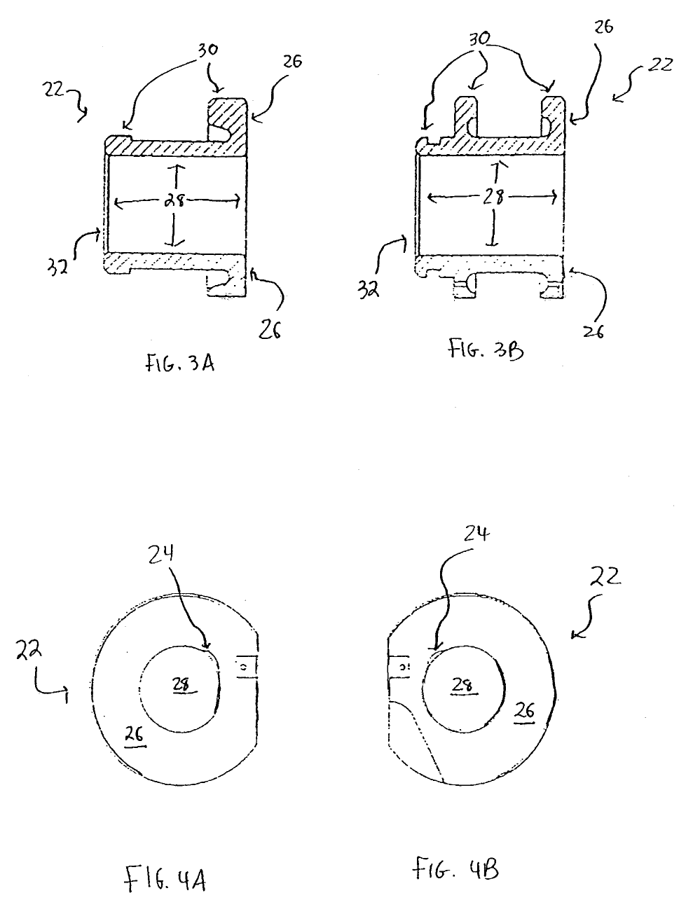

Prior to being restored, the bearings 22 are cleaned to remove grease, dirt, grime and/or other substances that have accumulated on or within the bearings 22 during the course of their use. In particular, the cleaning process preferably targets such substances that have accumulated on the top surface 26 (see FIGS. 3A, 3B, 4A and 4B) of the bearings 22, and the bore 28 (i.e., journal area) defined within the bearings (see FIGS. 3A and 3B).

In accordance with the cleaning process, the bearings 22 are exposed to a cleaning solution/agent. The particular solution used, as well as the cleaning conditions, should both be selected to be effective to eliminate substances that have accumulated upon the surfaces (especially the top surface 26) and within the journal areas 28 of the bearings 22 without, in so doing, compromising the structural integrity of the bearings.

Generally, the cleaning solution is a degreasing and/or de-carbonizing solution. Exemplary such solutions include, but are not limited to, SF-1 Solvent Free Degreaser, which is commercially available from L&R Manufacturing Company of Kearney, N.J., USA, and Jet-Lube 5000 Cleanser and Degreaser, which is commercially available from Jet Lube, Inc. of Houston, Tex., USA.

It is understood, however, that other suitable cleaning solutions may be used in lieu of, or in addition to (e.g., combined with or separately) this solution depending on the amount and/or type of substances that have accumulated on the bearings 22, and that must, therefore, be removed therefrom prior to continuing the restoration process.

Although the cleaning solution may be directly applied to the bearings 22, it is instead preferred that the solution be placed in a containment area (not shown) into which the bearings will be placed, and under conditions that lend themselves to thorough removal of dirt, grease, grime and other substances from the bearings. The dimensions of the containment area will vary in accordance with spatial limitations and the number of bearings 22 that are to be simultaneously cleaned in accordance with the invention.

Generally, the containment area is an ultrasonic bath that is heated to a predetermined heating temperature, which is preferably less than 212° F., more preferably in the range of about 160° F. to 190° F., most preferably about 180° F. The bearings 22 are then placed within the bath for a predetermined time, preferably about 60 minutes, during which the bath is preferably maintained at a temperature substantially equal to the predetermined heating temperature. Following their removal from the bath, the bearings are rinsed clean (e.g., with water) and then are either allowed to dry or, preferably, are blown dry via blown or forced air.

Thereafter, the bearings 22 may be subjected to further cleaning efforts in order to remove more stubborn dirt, grease, grime and other substances that may have adhered to the bearings. For example, the outer landings 30 (see FIGS. 3A and 3B) of the bearings 22 may be cleaned (e.g., by hand) using an abrasive material (e.g., Scotch Brite Hand Pad #6448 (Dark Gray) or Scotch Brite Hand Pad #7445 (White), both of which are commercially available from 3M of St. Paul, Minn., USA) to assuredly remove such substances from the bearings.

Also, the bearings 22 may be subjected to grit blasting and (thereafter and/or prior thereto) can be shot with glass beads. Both of these procedures may be carried out using equipment and under conditions that are generally known in the art. By way of non-limiting example, the glass beads used may be Ballotini Impact Beads, size AD 70-140 US Sieve, which are commercially available from Potters Industries Inc. of Valley Forge, Pa., USA.

Preferably, prior to the bearings 22 being grit blasted and/or being shot with glass beads, the outer landings 30 (and/or other areas) of the bearings are covered with a protective material (e.g., a foil tape) to protect the structural integrity of the bearings during the blasting/shooting process(es).

Once the bearings 22 have been sufficiently cleaned, they are treated in accordance with one or more treatment steps in accordance with the bearings restoration methods of the present invention.

The purpose of these treatment efforts is two fold—to properly dimension the bearings 22 for subsequent application of a resurfacing compound and, later, a coating material, and also to treat any areas of the bearings that may have become pitted or cavitated due to fluid having eroded/worn away the bearings (especially the top surface 26, journal area 28, grooves and ramps) during their use.

In furtherance of such treatments, the bearings 22 are mounted within equipment that allows for visual inspection (with the unaided eye or, preferably, with one or more visual enhancement devices, e.g., a magnifying glass) and highly accurate treatment of the bearings without compromising the structural integrity thereof.

It is currently preferred to mount each bearing 22 to be treated in a holding jig (not shown), which is then mounted in a lathe (not shown) or machine mill (not shown).

Because the bearings 22 may have a high lead content (and, thus, may be soft enough to be deformable), care should be taken to use mounting equipment that will not modify/distort the structure of the bearings 22. Moreover, following mounting (and prior to treatment thereof), the positional aspects (e.g., the centering) and the tolerances of the bearings should be verified as is generally known in the art.

It is understood that the bearings 22 may be prepared for treatment using alternative techniques and/or equipment known in the art.

Once the bearings 22 are prepared for treatment, a predetermined amount of bearing material is usually removed from (e.g., via machining) the top surface 26 and the journal area 28 of each bearing. The amount removed should be great enough to allow for proper amounts of resurfacing compounds and, later, top coating material to be applied to these areas of the bearings 22 to restore the as-manufactured dimensions and shape to the bearings. But because both the resurfacing compounds and top coating material are relatively expensive, the amount removed from these areas of the bearings 22 should not be overly excessive.

Preferably, the amount removed from each area of the bearings 22 should be within the range of about 0.06 inch to 0.35 inch, more preferably about 0.13 inch to 0.2 inch, most preferably about 0.18 inch.

Either prior to or, preferably, following such machining, the bearings 22 are examined for evidence of cavitation and/or pitting. As noted above, this is generally accomplished by visually inspecting the bearings 22 with the unaided eye, or, preferably, with the assistance of one or more visual enhancement devices (e.g., a magnifying glass).

If cavitated and/or pitted areas are present within the bearings 22 and are not properly treated, air can become trapped within these areas during subsequent steps of the process. The presence of air within these areas, in turn, can cause structural voids that can cause failure of the bearings 22 during use thereof.

If evidence of cavitation and/or pitting is located, the cavitated and/or pitted areas are treated with a suitable device, e.g., a pencil-type burr tool. Through use of such a device, the cavitated and/or pitted areas are smoothed, thus rendering them amenable to being filled with resurfacing compound material(s) without developing voids.

The cavitated and/or pitted areas should be filled with enough of the resurfacing compound(s) to bring these areas level with the machined surfaces of the bearings 22 in which these areas are defined—that is, such that the dimensions of these areas match the dimensions of the already machined areas of the bearings. The process of applying the resurfacing compound will be described in detail below.

Once the bearings 22 have been treated, they are removed from the aforementioned machining jigs. Again, care should be taken not to physically damage the bearings 22 during this unloading process.

It is likely that the bearings 22 will have become at least partially soiled during the treatment steps of the restoration process. This is because substances (e.g., oil) are generally used to provide lubrication during the treatment process, usually in connection with machining the bearings 22.

In order to remove these substances, the bearings should be further cleaned using a cleaning solvent/solution. This solution may be identical to the solution that was used to initially clean the bearings, or may be a different solvent/solution.

Generally, a different solution is used because the substances that need to be removed are topical due to their having been applied recently. It is important that this solvent not leave a residue following it use, as the presence of a residue could impede subsequent application of resurfacing compound and top coating material. It is important, however, that this solvent, if different from the solution used to initially clean the bearings, also not be harmful to the structural integrity of the bearings 22.

An exemplary such solvent is Belzona® 9111 Cleaner/Degreaser, which is commercially available from Belzona Inc. of Miami, Fla., USA, but it is understood that other appropriate solutions and/or solvents may also/instead be used. Other exemplary solvents include, e.g., methyl ethyl ketone-based (MEK-based) cleaners.

The solvent may be directly applied to the bearings 22 or, preferably, may be placed within a container (not shown) within which the bearings are then placed so as to be completely submerged. Once removed from the solvent-filled container, the bearings 22 are either allowed to dry or, preferably, dried via forced or blown air. Once dry, the bearings 22 are preferably placed within a covered container to avoid contact with airborne contaminants and/or substances—that is, the bearings are placed in one or more covered containers to maintain their level of cleanliness.

The bearings 22 are subsequently removed from the container(s) to be resurfaced with one or more resurfacing compounds. The resurfacing compound should be relatively hard and quick drying, yet should allow for bonding/blending with the existing materials that comprise the bearings such that the resurfacing compound will not flake or peel following its application to the bearings.

Suitable resurfacing compounds include, but are not limited to, polymer compounds such as Belzona® 1391 polymer resurfacing coating, which is commercially available from Belzona Inc of Miami, Fla., USA.

The Belzona® 1391 coating is commercially available as a two-part (one part base, one part solidifier) putty-like compound and, therefore, must be blended together prior to being applied onto the bearings 22. Generally, the compound is blended together in ratios of about 5 parts base to 1 part solidifier (by volume) and about 13 parts base to 1 part solidifier (by weight).

This blending step can introduce air (e.g., as bubbles and/or in pockets) into the blended resurfacing compound. If the compound is applied to the bearings 22 without eliminating these air bubbles, structural voids can develop within the bearings that, in turn, can lead to failure of the bearings during use thereof.

Therefore, in a preferred embodiment of the present invention, the resurfacing compound is de-aerated to eliminate air trapped within the compound as a result the blending/mixing step.

By way of non-limiting example, de-aeration may be affected by hand. This may entail, for example, spreading the mixed resurfacing compound onto a substantially smooth surface, where the spread compound can be inspected for trapped air. Both the surface onto which the compound is spread, and the implement used to spread the compound should be substantially non-stick. By way of non-limiting example, the implement may be a plastic (e.g., polytetrafluoroethylene) spatula-like implement, and the surface may be glass.

The compound should be spread such that any bubbles that are present can be noticed, e.g., via the unaided or aided eye. To allow for such visualization, it is preferred that the compound be spread to a thickness of no more than 0.0625 inch.

If, after the compound is spread onto this surface, air bubbles, air pockets, and/or so-called “pinholes” are visualized, they are eliminated, e.g., by pressing upon the compound with the spatula. One the compound has been de-aerated as such, it is preferred that the compound be regathered, and that the de-aeration process be repeated at least once, preferably at least twice.

Although the compound can be regathered with the same implement used to spread and de-aerate the compound, it is preferred to instead use a different implement that includes sharper edges to expedite the regathering process, and to ensure that little to no compound is wasted (e.g., by sticking to the spreading surface). The regathering implement also preferably is made of a non-stick plastic, e.g., polytetrafluoroethylene.

Care should be taken to ensure that the duration of the entire deaeration process is less than a predetermined time, which represents the time during which the compound (once exposed to air after being stored at a certain temperature) will dry to an extent that will not allow it to be spread.

In the case of Belzona® 1391, the temperature at which it is stored is generally in the range of about 70° F. to 75° F. At this temperature, the Belzona 1391 compound generally will harden (to an extent that will prevent it from being spread) in about 30 minutes. Thus, the de-aeration process should take no more than 15 minutes, preferably no more than 10 minutes. This will allow for ample time (i.e., 15-20 minutes) to spread the compound onto the bearings 22 once the compound has been de-aerated.

A predetermined thickness of the de-aerated compound is then applied to the areas of the bearings that require restoration. This predetermined thickness is generally in the range of about 0.03 inch to 0.34 inch, more preferably about 0.10 inch to 0.17 inch, most preferably about 0.15 inch.

Generally, the compound is applied using the spreading implement, but application thereof may be effected through the use of additional and/or alternate implements as well. Such additional implements also preferably should be made of a non-stick plastic material, e.g., polytetrafluorethylene.

In an exemplary embodiment of the present invention, the bearings 22 are positioned (during the resurfacing compound application process) such that the top surface 26 thereof is pointed upwards. Thus, the compound can be applied evenly to this surface 26 with little difficulty, and the thickness of application can be gauged as the compound is being applied.

By virtue of this orientation, however, the compound that is applied to the bearing surface within the journal area 28 is susceptible (due to the force of gravity) to flowing downward, even if it is initially applied evenly.

To prevent this from occurring (or at least to minimize the extent it occurs), in a preferred embodiment of the present invention, once the compound has been initially applied to the journal area 28 of the bearings 22, a plug (not shown) is immediately introduced within this area 28, preferably into the bottom opening 32 (see FIGS. 3A and 3B) of the bearing.

This plug preferably has a diameter that is substantially similar to, but slightly less than the diameter of the journal area 28, such that the plug, once introduced within the journal area, can fit snugly therewithin. The plug is preferably made of a non-stick plastic material (e.g., polytetrafluoroethylene) and, itself, is coated with some of the resurfacing compound prior to being introduced into the journal bore 28.

Upon being introduced into the journal area/bore 28, the plug is preferably twisted (e.g., by hand) at least 90°, and up to (or even more than) 360° to ensure a snug fit within the journal area. This twisting action may cause some compound material to ooze from within the journal area 28 of the bearings 22 onto the top surface 26 of the bearing.

For this reason, it is preferred that the journal area 28 of the bearing 22 be the first area (following any pitted and/or cavitated areas) of the bearings to be coated. This allows any oozed compound to be smoothed onto the top surface 26 of the bearing 22 onto which it has flowed. Such an approach minimizes waste of the compound material.

Once the compound has been applied in the predetermined thickness to all desired areas of the bearings 22, the bearing is preferably visually inspected (either with an unaided or, preferably, aided eye) for the presence of air bubbles. If a predetermined number/quantity of air bubbles are visualized, the compound is not further treated (for fear that the air bubbles will become voids that, in turn, will compromise the structural integrity of the bearings 22 during use). Rather, the compound is dried or allowed to dry, and then the bearings 22 are again treated (i.e., machined) as described above to prepare for reapplication of the compound.

If, instead, fewer than this predetermined number/quantity of air bubbles are detected, the bearing is placed within a vacuum chamber (not shown) for a predetermined amount of time, and at a predetermined temperature and pressure that, collectively, are selected such that the compound will dry in an appropriately-pressurized environment.

In an exemplary embodiment of the present invention, the temperature within the vacuum chamber is in the range of about 70° F. to 75° F., and the pressure therewithin is in the range of about 20 inches of mercury to 24 inches of mercury. Under such conditions, the bearings 22 should be allowed to remain within the vacuum chamber for a time in the range of about 4.5 hours to 5.0 hours.

Optionally, the bearings 22 also may be cured as is generally known in the art, preferably at a temperature of about 180° F. for a time in the range of about 4 hours to 5 hours.

Preferably, the plug remains within the journal areas 28 of the bearings 22 during both the vacuum and curing steps of the process. This ensures that the compound within the journal area 28 will not slump or sag, thus, in turn, ensuring that the compound remains evenly applied at the predetermined application thickness throughout the journal area.

Following the curing step, each plug is removed from each journal area 28 of each bearing 22. Removal can be effected easily, because the plug is made of a non-stick material. Generally, the plugs are removed either by pushing them such that they emerge out of either the top surface 28 or bottom opening 30 of the bearings. Such pushing can be (and preferably is) accompanied by simultaneous twisting of the plug, preferably in a direction opposite the direction in which the plugs were twisted upon being introduced into the bearing 22.

At this point in the restoration process of the present invention, the bearings are nearly fully restored.

As indicated in FIG. 9, the remainder of the bearing recreation processes of the present invention generally will be identical if the bearings are being restored as described above, or, instead, if the inner and/or outer core of the bearings are being replaced, e.g., due to excessive damage that would prevent repair/restoration of the bearings either at all or in an economic manner.

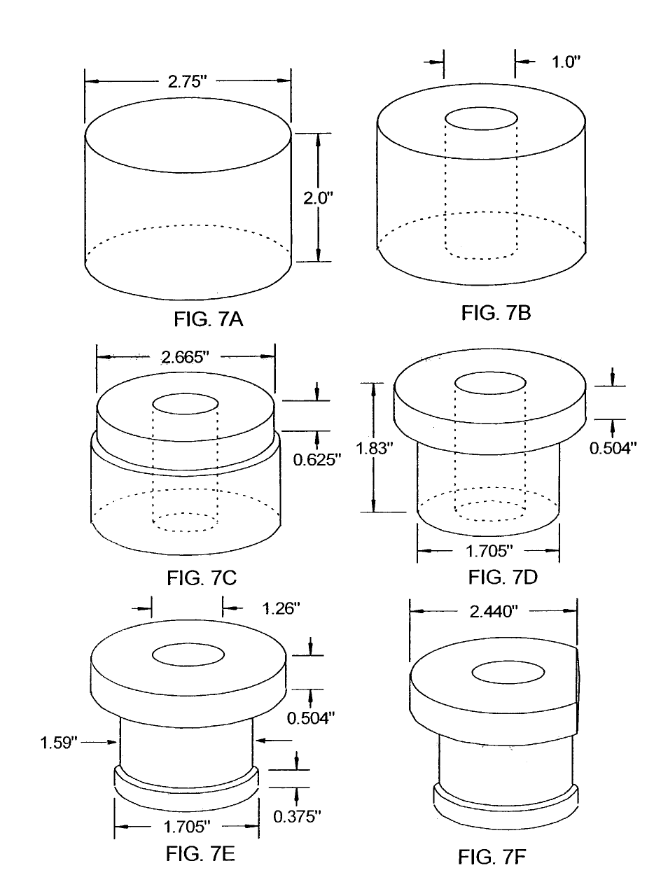

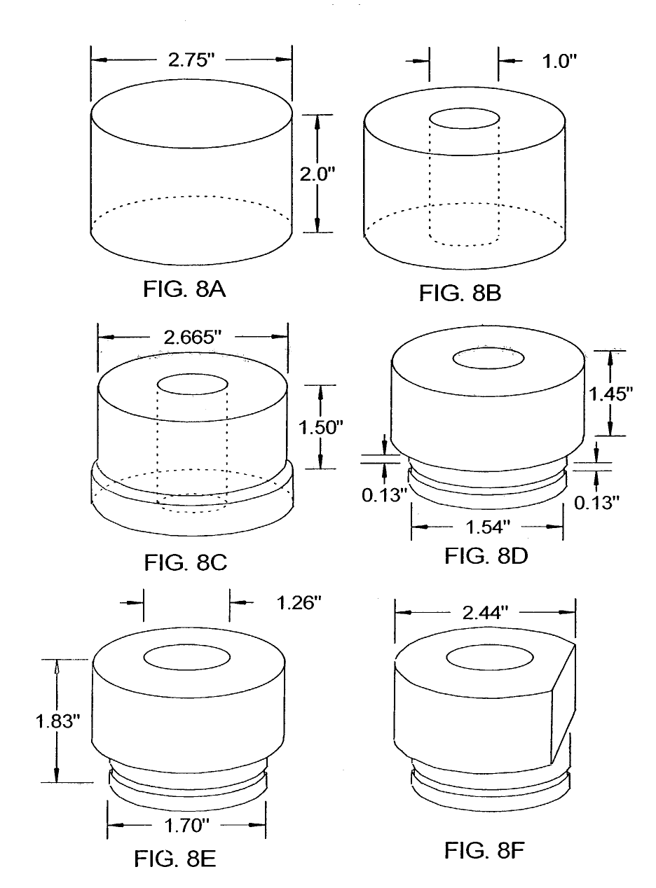

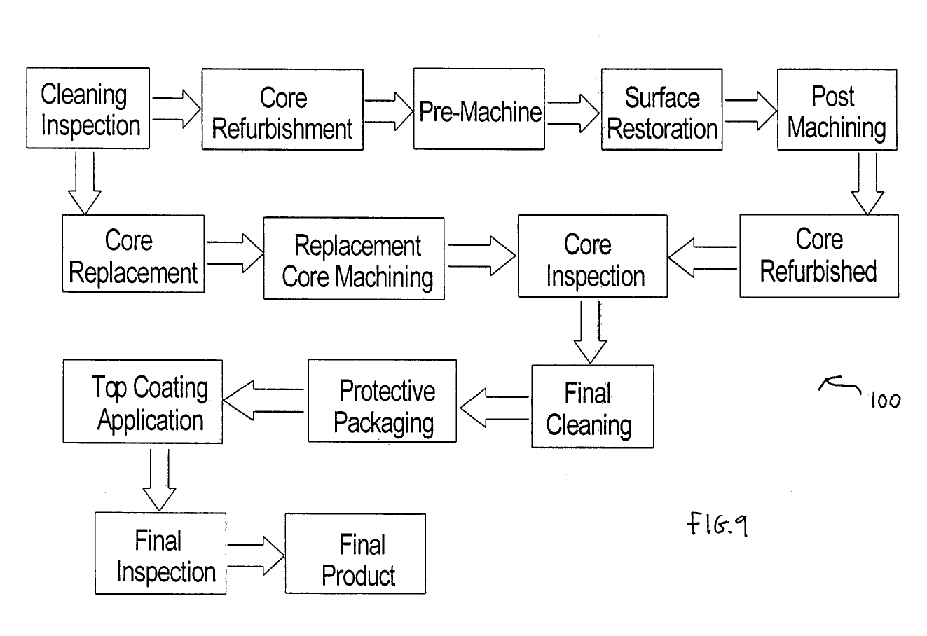

If the bearings are being replaced, new inner and/or outer bearing cores will need to be fashioned prior to continuing onto the next common step in the flow process of FIG. 9. The steps for making a new outer bearing core is shown in FIGS. 7A-7F, and the steps for making a new inner bearing core is shown in FIGS. 8A-8F.

In an exemplary embodiment of the present invention, the steps for making a new outer bearing core are as follows. The numerical values in the following embodiment are merely exemplary, and can vary above and/or below the given values as desired or as dictated.

A 2.75 inch by 2.0 inch “blank” of a metal material (FIG. 7A) is mounted on a lathe chuck (not shown) and is bored with a 1.0 inch hole through its center (FIG. 7B). The outer diameter of the top 0.625 inch of the metal is then reduced from 2.75 inches to 2.65 inches (FIG. 7C). The material is then removed from the lathe chuck, rotated 180°, and remounted on the lathe chuck, after which the lower 1.83 inch portion of the material is cut such that the outer diameter of that portion is 1.705 inch, thus creating a 0.504 inch shoulder that has a diameter of 2.75 inches (FIG. 7D).

The diameter of the area between the lower 0.375 inch of the 1.705 diameter portion and the bottom of the 0.504 inch shoulder is cut so as to be reduced to 1.59 inch (FIG. 7E). Although not shown, the top shoulder then can be cut at 0.5 inch from the top face, and the edges of the lower landing can be chamfered at 45° by 0.02 or 0.03 inch.

The center bore is then widened from 1.0 inch to 1.26 inch (FIG. 7F), after which the material is removed from the lathe and placed in a horizontal holding jig (not shown) and centered. While on this jig, one side of the top landing is milled flat to a distance of 2.44 (FIG. 7F).

An exemplary process of forming a new inner bearing core is shown in FIGS. 8A-8F. In accordance with this process, a 2.75 inch by 2.0 inch “blank” of the metal material (FIG. 8A) is mounted on a lathe chuck (not shown) and is bored with a 1.0 inch hole through its center (FIG. 8B). The outer diameter of the top 1.5 inch of the metal is then reduced from 2.75 inches to 2.665 inches (FIG. 8C).

The material is then removed from the lathe chuck, rotated 180°, and remounted on the lathe chuck, after which the lower 0.55 inch portion of the material is cut such that its outer diameter is 1.703 inch, thus creating a 1.45 inch shoulder that has a diameter of 2.665 inches (FIG. 8D). As shown in FIG. 7D, a 0.13 inch wide 0.08 inch deep groove is cut into the lower 0.55 inch portion of the material such that the diameter of the grooved portion of the material is 1.54 inch. The top and bottom of the groove are, respectively, 1.70 inch and 1.83 inch from the top of the material (FIG. 8E).

The center bore is then expanded to 1.26 inch (FIG. 8E), after which the material is removed from the lathe and placed in a horizontal holding jig (not shown) and centered. While on this jig, one side of the top landing is milled flat to a distance of 2.44 (FIG. 8F).

In exemplary embodiments of the present invention, the metal material from which the outer and inner bearing cores are fashioned are made of bronze, stainless steel or, preferably, aluminum, e.g., Alum 6061. Aluminum is preferred because it is inexpensive and easy to machine.

As noted above, the remaining portions of the bearing recreation processes of the present invention (described in detail below) are generally identical whether the bearings are being restored or, instead, replaced.

The bearings 22 are examined to determine the difference between the thickness of the bearings, and the desired as-manufactured thickness of the bearings. This is generally accomplished by again mounting the bearings within a holding jig (not shown), which is then mounted either in a lathe (not shown) or machine mill (not shown).

The thickness of the bearings should be less than the as manufactured bearing thickness by a predetermined amount that is selected to ensure that enough, but not too much, top coating material may be subsequently applied to the bearings in order to restore the bearings to their as-manufactured dimensions and shape.

The coating material provides the bearings with an extremely hard, yet smooth and slippery surface that resists wear. But the coating also is expensive. Therefore, if too little coating material is applied, the bearings 22 will not be hard enough and will not be sufficiently wear resistant, while if too much material is applied, the process is rendered unnecessarily expensive. In a preferred embodiment of the present invention, this predetermined amount is in the range of about 0.03 inch to 0.15 inch, more preferably about 0.03 inch to 0.05 inch, most preferably about 0.03 inch.

If the current thickness of the bearings 22 is less than the as manufactured thickness of the bearings by an amount greater than the predetermined amount, additional resurfacing compound is applied as noted above.

If, instead, the current thickness of the bearings 22 is less than the as-manufactured thickness of the bearings by an amount less than the predetermined amount, excess thickness may be removed by machining the bearings as described above.

At this time, the bearings 22 are ready for application of the coating material; however, prior to such application, it is preferred that the bearings 22 first be cleaned, e.g., with an alcohol. Also, the bearing 22 should be placed in a closed/sealed environment until immediately prior to being coated to prevent the surfaces of the bearings from being exposed to airborne contamination.

The material used to coat the bearings 22 should provide the bearing surfaces to which it is applied with durability, hardness, and a substantially frictionless contact surface. The material also should be compatible with hydrocarbon-based fuel oils and synthetic-based lubricants. Exemplary such materials are high performance fluoropolymers including, but not limited to, Fluoralon B5525, which is commercially available from Fluorocarbon Co. Ltd. of Caxton Hill, Hertford, United Kingdom.

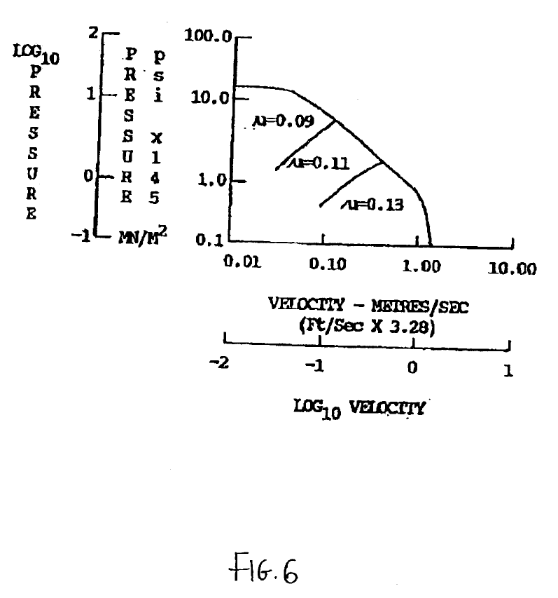

Fluoralon B5525 has an operating temperature range of between about −391° F. and 545° F., a compressive strength of about 52,000 psi, a wear factor of about 4.5×10⁻¹⁰ in³/lb×min/ft×hour, a wear depth (in microns/100 hours) of about 3.2×10⁻⁵×pressure [MN/m²]×velocity [m/s] for test configurations inside PV limit (as shown in FIG. 6), and wear depth (in mirco inches/100 hours) of about 2.7×10⁻⁶×pressure (psi)×velocity (ft/s) for test configurations inside PV limit (as shown in FIG. 6).

It is important that the coating material be applied evenly and in a precise manner to the bearings 22, such that following application of the coatings, the bearings have returned to their as-manufactured dimensions. To ensure such evenness and precision, it is preferred that the coating be applied via an automated or computerized spray nozzle device, as is generally known in the art.

Following application of the coating, the bearings 22 are cured (e.g., in a curing oven) until the coating material has dried. Once the bearings are removal from the curing environment, their dimensions are examined to check for tolerance to the original bearing specifications.

Also, at this time, the journal skates 28 are checked and, if necessary, lubrication holes are cleared to ensure that fluid (i.e., fuel oil) can flow therethrough to the impeller gear journal areas (not shown).

Thereafter, a bore jig (not shown) is used to check the slip fit of the outside diameter clearance of the bearings 22 to the precision bore of the main pump (not shown), and also to check the clearance of the mating bearing surfaces.

The bearings 22 are then placed (with their respective impeller gears 10, 12) back into the fuel pump (not shown), after which the reassembled fuel pump preferably is tested in manners known in the art in order to verify that the pump can operate under envisioned flow and pressure levels. If the fuel pump is deemed to have satisfactorily passed this/these test(s), it is remounted onto the gas turbine (not shown) for operation.

The foregoing description of the invention is merely illustrative thereof, and it is understood that variations and modifications can be effected without departing from the scope or spirit of the invention as set forth in the following claims. All documents mentioned herein are incorporated by reference herein in their entirety.

What is claimed is:

1. A method for recreating a fuel pump bearing, comprising the steps of:
cleaning the bearing using at least one cleaning agent;
treating the bearing to effect removal of at least some bearing material;
introducing a resurfacing compound onto at least one predetermined area of the bearing; and
introducing a coating onto the at least one predetermined area of the bearing, such that the bearing, following the coating step, has a shape and dimensions that substantially resemble the shape and dimensions of the bearing as-manufactured.

2. The method of claim 1, wherein the step of cleaning the bearing with the cleaning agent includes:
placing the agent in a containment area that is heated to a predetermined temperature; and
placing the bearing into the containment area for a predetermined time.

3. The method of claim 2, wherein the containment area is an ultrasonic bath.

4. The method of claim 2, wherein the predetermined temperature is less than 212° F. but also at least 160° F., and wherein the predetermined time is about 60 minutes.

5. The method of claim 1, wherein the bearing includes a plurality of outer landings, and wherein the step of cleaning the bearing further includes the step of cleaning the outer landings with an abrasive material.

6. The method of claim 1, wherein the step of cleaning the bearing further includes at least one of the steps from the group consisting of grit blasting the bearing, and shooting the bearing with glass beads.

7. The method of claim 1, wherein the step of treating the bearing includes machining the bearing such that the bearing, following machining, has dimensions that are less than the as-manufactured dimensions of the bearing by a first predetermined amount.

8. The method of claim 7, wherein the first predetermined amount is about 0.18 inch.

9. The method of claim 1, wherein the step of treating the bearing includes smoothing at least one area selected from the group consisting of one or more cavitated areas of the bearing and one or more pitted areas of the bearing.

10. The method of claim 1, wherein the bearing is further cleaned prior to the step of introducing the resurfacing compound, but following the step of treating the bearing.

11. The method of claim 7, wherein the resurfacing compound is applied to the bearing such that the bearing, following application of the resurfacing compound, has dimensions that are less than the as-manufactured dimensions of the bearing by a second predetermined amount.

12. The method of claim 11, wherein the second predetermined amount is less than the first predetermined amount.

13. The method of claim 11, wherein the second predetermined amount is about 0.03 inch.

14. The method of claim 1, wherein the coating is applied to the bearing through the use of a device selected from the group consisting of an automated spray device and a computerized spray device.

15. The method of claim 1, wherein the resurfacing compound is a two-part compound that includes a predetermined weight percentage and predetermined volume percentage of a base component, and a predetermined weight percentage and predetermined volume percentage of a solidifier component.

16. The method of claim 15, wherein the predetermined weight percentage of the base component is greater than the predetermined weight percentage of the solidifier component, and wherein the predetermined volume percentage of the base component is greater than the predetermined volume percentage of the solidifier component.

17. A method for recreating a fuel pump bearing, comprising the steps of:
initially cleaning the bearing using at least one cleaning agent;
machining the bearing to effect removal of at least some bearing material;
further cleaning the bearing to effect removal of at least some of one or more substances that accumulated on the bearing during the step of machining the bearing;
preparing a resurfacing compound;
introducing a resurfacing compound onto at least one predetermined area of the bearing; and
introducing a coating onto at least one predetermined area of the bearing, such that the bearing, following the coating step, has a shape and dimensions that substantially resemble the shape and dimensions of the bearing as-manufactured.

18. The method of claim 17, wherein the resurfacing compound is a two-part compound that includes base and solidifier components, and wherein the step of preparing the resurfacing compound includes:
mixing predetermined weight and volume percentages of the base component and the solidifier component material on a mixing surface with at least one mixing implement; and
regathering the mixed compound with a regathering implement.

19. The method of claim 18, wherein the mixing surface is a glass material, and both the mixing implement and wherein the regathering implement are made of a substantially non-stick material.

20. The method of claim 19, wherein the mixing implement and the regathering implement are made of polytetrafluoroethylene.

21. The method of claim 17, wherein the resurfacing compound, prior to being prepared, is stored at a predetermined temperature, and wherein the steps of preparing the compound and introducing the compound are performed within a predetermined time limit that is dependent upon the predetermined temperature at which the compound was stored prior to being prepared.

22. The method of claim 21, wherein the predetermined time limit is about 30 minutes when the predetermined temperature at which the resurfacing compound was stored was in the range of about 70° F. to 75° F.

23. The method of claim 17, wherein the bearing includes a top surface and a bore area, and wherein the step of introducing the resurfacing compound includes the steps of:
applying at least some resurfacing compound to at least one of the top surface and the bore area of the bearing;
applying at least some resurfacing compound to a plug; and
inserting the plug within the bore area of the bearing.

24. The method of claim 23, wherein the plug is made of a substantially non-stick material.

25. The method of claim 23, wherein the top surface of the bearing is oriented upwardly during at least a portion of the step of introducing the resurfacing compound.

26. The method of claim 23, wherein the resurfacing compound is first applied to the bore area of the bearing, after which resurfacing compound is applied the plug, after which the plug is introduced into the bore area, after which the resurfacing compound is applied to the top surface of the bearing.

27. The method of claim 23, wherein the plug is removed from within the bore area prior to the step of introducing the coating.

28. The method of claim 17, further including the steps of:
placing the bearing into separate pressurized and heated environments prior to the step of introducing the coating, but following the step of introducing the compound.

29. A method for recreating a fuel pump bearing, comprising the steps of:
initially cleaning the bearing using at least one cleaning agent;
machining the bearing such that the bearing, following machining, has dimensions that are less than the as-manufactured dimensions of the bearing by a first predetermined amount;
further cleaning the bearing to effect removal of at least some substances that accumulated on the bearing during the step of machining the bearing;
preparing a resurfacing compound;
introducing a resurfacing compound onto the bearing such that the bearing, following application of the resurfacing compound, has dimensions that are less than the as-manufactured dimensions of the bearing by a second predetermined amount, wherein the second predetermined amount is less than the first predetermined amount;
ensuring that the steps of preparing the resurfacing compound and introducing the resurfacing compound onto the bearing are completed within a predetermined time window that is based on the temperature at which the resurfacing compound was stored prior to being prepared;
placing the bearing into separate pressurized and heated environments prior to the step of introducing the coating, but following the step of introducing the compound; and
introducing a coating onto at least one predetermined area of the bearing, such that the bearing, following the coating step, has a shape and dimensions that substantially resemble the shape and dimensions of the bearing as-manufactured.
